(19) United States
(12) Patent Application Publication
(10) Pub. No.: US 2021/0286061 A1
(43) Pub. Date: Sep. 16, 2021

(54) METHOD FOR DETERMINING A DEPTH OR A BATHYMETRIC PROFILE BASED ON AN AVERAGE SOUND SPEED PROFILE, METHOD FOR DETERMINING SUCH A SPEED PROFILE, AND RELATED SONAR SYSTEM

(71) Applicant: IXBLUE, Saint-Germain-en-Laye (FR)

(72) Inventor: Didier CHARLOT, Saint-Germain-en-Laye (FR)

(21) Appl. No.: 17/275,872

(22) PCT Filed: Sep. 12, 2019
(86) PCT No.: PCT/EP2019/074357

§ 371 Date: Mar. 12, 2021

(30) Foreign Application Priority Data
Sep. 14, 2018 (FR) 1858281

(51) Int. Cl. G01S 7/53; G10K 11/20; G01S 15/42; G01S 15/89

(52) U.S. Cl. CPC G01S 7/53; G01S 15/8902; G01S 15/42; G10K 11/205

(57) ABSTRACT

Disclosed is a method for determining a difference in depth or a lateral distance in relation to the vertical between two points of an underwater environment, in particular by measuring a propagation time of a sound wave. The determination is based on a single-layer model of the environment in which the wave is supposed to propagate in a straight line along an effective propagation direction, at a mean velocity that is independent of the propagation direction. Also disclosed is a method for determining the profile of the mean velocity based on the measurements of differences in depths per se, a determination of the local velocity profile over the variation interval of the sounded depths, and a related sonar system.

### TECHNICAL FIELD TO WHICH THE INVENTION RELATES

The present invention generally relates to the determination of a depth difference, or the determination of a lateral deviation with respect to the vertical between two points of an underwater environment, by measuring a propagation time and/or a propagation constant of a sound wave propagating between these two points, based on a mean velocity in this underwater environment.

It applies in particular to the measurement of a seafloor topography, and to the localization of a submerged object or fish shoal. It also applies to the determination of said mean velocity, from the topographic measurements themselves.

### TECHNOLOGICAL BACK-GROUND

Today, more and more vessels are equipped with sonars, whether they are surface or submarine, manned vessels or drones. In particular, more and more “AUV” (“Autonomous Underwater Vehicle”) and “USV” (“Unmanned Surface Vehicle”) drones are now equipped with sonars. Such sonars notably make it possible to determine a bathymetric profile of the seafloor situated below the vessel (such a profile gathering, for several points of the seafloor, depth and horizontal position data locating these points of the floor), or to localize an object or a fish shoal situated in a water column extending below this vessel.

To determine the depth of a point of the seafloor situated vertically below the sonar, the latter emits a sound wave towards this point. After reflection on the floor, this sound wave is received by one or several receivers fitted on the sonar. The duration between the times of emission and reception of the sound wave, which is equal to the time necessary for the sound wave to make a round-trip travel between the sonar and the seafloor, can hence be used to determine the depth at which this point of the seafloor is situated. For that purpose, half of this duration is multiplied by a given velocity value of the sound waves in the environment.

But such a depth determination is often inaccurate because the velocity of the sound waves in an underwater environment generally varies as a function of the depth (due, in particular, to variations of temperature, density or salinity with depth).

The “Manual on Hydrography” from the International Hydrographic Organization (publication C-13, 1^{st} Edition, Corrections to February 2011, available on the Internet site https://www.iho.int/iho_pubs/CB/C13_Index.htm#C-13F), proposes, in order to determine the depth of a point of the floor situated vertically below the sonar:
previously to the above-mentioned echo time measurements, to survey a velocity profile, i.e. a set of velocity values locally exhibited, at different points situated more or less deeply below the water surface, by sound waves, then
to use an effective velocity, equal to the harmonic mean, along the considered water column, of the previously-surveyed velocity values (paragraph 2.2.4 in Chapter 3 of this document).

As it is a harmonic mean, the inverse of this effective velocity is equal to the arithmetic mean of the inverses of said local sound velocity values.

For a point of the floor that is not situated vertically below the sonar, the sound wave is deviated by refraction, all along its travel between the sonar and the sounded point (due to the variation of the sound wave velocity with depth). This is the propagation time of the wave, along this non-straight line travel, that is hence measured by the sonar.

To determine the depth of such a point, and its lateral deviation with respect to the sonar (deviation with respect to the vertical), the above-mentioned document indicates (page 121) that it is necessary to plot, point-by-point, the path followed by the sound rays, deviated under the effect of the above-mentioned refraction. This document more precisely proposes (page 161) to model the underwater environment as a stack of several layers, the sound wave velocity or the gradient thereof being supposed to be constant in each layer. The path of the sound rays is then determined gradually, layer by layer. This hence allows linking the time of propagation along this path to the depth of the sounded point and to lateral deviation thereof with respect to the sonar.

However, the path followed by the sound rays must be determined again, entirely, at each change of direction of the sound wave received by the sonar.

The implementation of this method hence involves many computations, and requires significant computer resources, in particular when multibeam sonars (which generate simultaneously a multitude of sound waves of different inclinations) are used. This method further requires a preliminary measurement of the sound wave velocity profile over the whole range of depths from the sonar to the sounded point.

### OBJECT OF THE INVENTION

In this context, the present invention proposes a method for determining a depth difference, or a lateral deviation with respect to the vertical between two points of an underwater environment, based on an appropriate single-layer model of the underwater environment, instead of being based on a multilayer model as described in the above-mentioned prior art (“Manual on Hydrography” from the International Hydrographic Organization). In this single-layer model, it is supposed that the sound wave propagates in a straight line in the environment, along an effective direction of propagation (different from its direction of reception), and with a mean velocity that is independent of this effective direction of propagation. Using this single-layer model significantly simplifies the computations required for such a determination, while producing very accurate results.

The invention provides in particular a method comprising the following steps:
emitting a sound wave in the underwater environment using at least one transmitter,
receiving said sound wave using a receiving antenna comprising several receivers, said receivers outputting a respective plurality of reception signals upon reception of said sound wave,
determining a propagation constant of the received sound wave, as a function of said reception signals, said propagation constant being equal to the sine of a reception angle indicating the direction of reception of the sound wave with respect to the vertical, divided by a local propagation velocity of the sound waves at the depth of said receiving antenna,
determining a propagation time of the sound wave, as a function of the duration separating the times of emission and reception of the sound wave,
determining the depth difference or the lateral deviation with respect to the vertical, between the receiving antenna and the transmitter, or between the receiving antenna and a submerged element reflecting said sound wave during its propagation from the transmitter to the receiving antenna, as a function of:
   a product of said propagation time by a mean velocity value of the sound wave at a depth of the transmitter or at a depth of the submerged element, said mean velocity value being representative of a harmonic mean of a plurality of local propagation velocities, exhibited by the sound waves at a respective plurality of depths from the depth of the transmitter to a depth of the receiving antenna, or from the depth of said submerged element to the depth of the receiving antenna, and as a function of
   a mean propagation angle, defined between the vertical and the effective direction of propagation of the sound wave, the mean propagation angle being determined as a function of said propagation constant and of said mean velocity value of the sound wave at the depth of the transmitter or at the depth of the submerged element.

The applicant has observed that, for a suitable value of said mean velocity, the depth difference or the lateral deviation determined as indicated hereinabove are surprisingly accurate enough with regard to the generally recommended international standards for hydrography (in particular with regard to the orders of accuracy “1b” and “special” as defined by the “IHO Standards for Hydrographic Surveys”, Monaco, 5^{th} Edition, said orders of accuracy being reminded on pages 8-10 of the above-mentioned “Manual on Hydrography” from the International Hydrographic Organization).

In this method, the influence of the refraction undergone by the sound wave is hence accurately taken into account, without thereby having to determine the detail of the path followed by the sound wave. This makes it possible to carry out the method advantageously rapidly and/or with limited computing resources.

It moreover turns out, as already indicated, that the suitable value of the mean velocity in question (for which an accurate determination of the depth difference and/or of the lateral deviation between the considered points is obtained) is independent of the inclination of the received sound wave. Thus, from the moment that this suitable value is known (or determined), several measurements of depth differences, nevertheless made for different inclinations, can be obtained by means of a same numerical formula, which noticeably reduces the computation time required for determining these depth differences.

Besides, it is to be noted that the depth difference and/or the lateral deviation mentioned hereinabove can be determined based on a single velocity value, instead of having to use many different velocities previously measured for the whole range of depths from the receiving antenna to the transmitter, or from the receiving antenna to said submerged element.

Other non-limitative and advantageous features of the determination method according to the invention, taken individually or according to all the technically possible combinations, are the following:
said mean velocity value is determined from a mean velocity profile, the mean velocity profile being determined by numerical integration of a local propagation velocity profile previously surveyed between the depth of the transmitter and the depth of the receiving antenna, or between the depth of said submerged element and the depth of the receiving antenna;
a displacement of the receiving antenna is provided in parallel to its longitudinal axis from a first position to a second position, and comprising the determination of a first propagation time of a first sound wave for the first position and a first propagation constant of the received sound wave, and, respectively, a second propagation time of a second sound wave for the second position and a second propagation constant, and wherein said mean velocity value is determined as a function of the first propagation time, the second propagation time and the second propagation constant;
it is provided to determine a mean velocity profile for a plurality of depths comprised between the depth of the transmitter and the depth of the receiving antenna, or between the depth of said submerged element and the depth of the receiving antenna, and to estimate a local propagation velocity profile by a numerical method of inversion from the mean velocity profile;
it is provided to determine both said depth difference and said lateral deviation with respect to the vertical;
said depth difference is determined in such a way as to exhibit a relative deviation lower than one per thousand with respect to:
   the product of said propagation time by said mean velocity value,
   multiplied by the cosine of said mean propagation angle;
said lateral deviation is determined in such a way as to exhibit a relative deviation lower than one per thousand with respect to:
   the product of said propagation time by said mean velocity value,
   multiplied by the sine of said mean propagation angle;
said mean velocity is representative of a harmonic mean of a plurality of local propagation velocities, exhibited by the sound waves at a respective plurality of depths from a depth of the transmitter to a depth of the receiving antenna, or from a depth of said submerged element to the depth of the receiving antenna;
the mean propagation angle is determined in such a way as its sine exhibits a relative deviation lower than one per thousand with respect to the product of said propagation constant by said mean velocity value;
the mean propagation angle is further determined as a function of an arithmetic mean velocity that is representative of an arithmetic mean of a plurality of local propagation velocities, exhibited by the sound waves at a respective plurality of depths from the depth of the transmitter to the depth of the receiving antenna, or from the depth of said submerged element to the depth of the receiving antenna;
the mean propagation angle is determined in such a manner that its sine exhibits a relative deviation lower than one per thousand with respect to said propagation constant, multiplied by said arithmetic mean velocity;
the transmitter and the receiving antenna are fitted on a same sonar system and, during the method, this sonar system determines the depth difference or the lateral deviation with respect to the vertical between the receiving antenna and a submerged element reflecting said sound wave during propagation thereof from the transmitter to the receiving antenna;
said transmitter belongs to a directional transmitting antenna of said sonar system, this transmitting antenna emitting said sound wave and comprising at least another transmitter;
the transmitter and the receiving antenna are respectively fitted on two distinct systems situated at different respective depths, and, during the method, the system provided with the receiving antenna determines the depth difference or the lateral deviation with respect to the vertical between the receiving antenna and said transmitter;
said receiving antenna comprises at least three receivers that are not aligned with each other, or, the system comprising said receiving antenna comprises at least another receiving antenna, a direction of reception of said sound wave being three-dimensionally located based on the reception signals output by both receiving antennas;
the transmitter is fitted on a submerged beacon;
the receiving antenna is fitted on a sonar system;
the method further comprises the following steps:
   determining, by means of a sounder positioned successively at several different depths, a plurality of local propagation velocities exhibited, at each of said depths, respectively, by the sound waves, then
   determining the local propagation velocity profile as a function of said previously-determined plurality of local propagation velocities;
the method further comprises the following steps:
   after the emission and the reception of said sound wave, displacing the sonar system, then,
   emitting another sound wave in the underwater environment using said transmitter, so that said other wave reaches said submerged element,
   after reflection on said submerged element, receiving said other sound wave using the receiving antenna,
   determining another propagation constant, for said other received sound wave, as a function of the reception signals output by the receivers of the receiving antenna after the reception of this other sound wave, said other propagation constant being equal to the sine of another reception angle indicating the direction of reception of said other sound wave with respect to the vertical, divided by a local propagation velocity of the sound waves by a local propagation velocity of the sound waves at the depth of said receiving antenna,
   determining another propagation time, as a function of another duration separating the times of emission and reception of said other sound wave, and
   determining said mean velocity as a function of:
      the propagation time and the propagation constant of said sound wave, and
      the propagation time and the propagation constant of said other sound wave;
said mean velocity value is determined in such a way as a deviation between:
   said depth difference, and
   a second depth difference between the receiving antenna and the submerged element
is lower than a given threshold, said second depth difference being determined as a function of:
   a product of said second propagation time by said mean velocity value, and as a function of
   another mean propagation angle, defined between the vertical and an effective direction of propagation of said other sound wave, said other mean propagation angle being determined as a function of said other propagation constant.

The invention also relates to a method for determining a local propagation velocity of the sound waves in an underwater environment, comprising the following steps:
for a plurality of submerged elements situated a different depths, determining a plurality of respective mean velocity values, each of said values being determined in accordance with the method described hereinabove, then
determining a plurality of local propagation velocities of the sound waves, for a plurality of given depths in the depth interval of the plurality of submerged elements, and in particular for each depth of each submerged element of said plurality of submerged elements, as a function of said previously-determined plurality of mean velocity values, and
determining at each of said submerged elements, from the previously-determined plurality of local propagation velocities and the associated propagation constants, the respective incidence angles of the sound wave.

The invention also relates to a method for determining a position of a submerged transmitter in an underwater environment, comprising the following steps:
emitting a sound wave in the underwater environment using said transmitter, whose depth is known,
receiving said sound wave using a receiving antenna fitted on a surface or submersible vessel, the receiving antenna comprising several receivers outputting a respective plurality of reception signals,
determining a propagation constant of the received sound wave, as a function of said reception signals, said propagation constant being equal to the sine of a reception angle indicating the direction of reception of the sound wave with respect to the vertical in the vertical plane containing the transmitter and the receiving antenna, divided by a local propagation velocity of the sound waves at the depth of said receiving antenna,
determining an effective direction of propagation of the sound wave as a function of the product of said propagation constant and a mean propagation velocity value at the depth of the submerged transmitter, said mean velocity value being representative of a harmonic mean of a plurality of local propagation velocities, exhibited by the sound waves at a respective plurality of depths between the depth of the transmitter and the depth of the receiving antenna, and
determining a lateral deviation with respect to the vertical between the receiving antenna and the transmitter, as a function of the product of:
   the difference between the depth of the transmitter and the depth of the receiving antenna, and of
   the tangent of a mean propagation angle defined between said effective direction of propagation and the vertical, the mean propagation angle being determined as a function of said propagation constant and said mean velocity value of the sound wave at the depth of the transmitter.

The transmitter can in particular be fitted on a submerged beacon, whereas the receiving antenna is fitted on the sonar system.

The invention also relates to a sonar system comprising:
a receiving antenna configured to receive a sound wave that has been previously emitted in an underwater environment by at least one transmitter, the receiving antenna comprising several receivers adapted to output a respective plurality of reception signals upon reception of said sound wave, and
an electronic processing unit programmed to:
   determine a propagation constant of the received sound wave, as a function of said reception signals, said propagation constant being equal to the sine of a reception angle indicating the direction of reception of the sound wave with respect to the vertical, divided by a local propagation velocity of the sound waves at the depth of said receiving antenna,
   determine a propagation time of the sound wave, as a function of a duration separating the times of emission and reception of the sound wave, and to
determine a depth difference or a lateral deviation with respect to the vertical, between the receiving antenna and the transmitter, or between the receiving antenna and a submerged element reflecting said sound wave during its propagation from the transmitter to the receiving antenna, as a function of:
   a product of said propagation time by a mean velocity value of the sound wave, said mean velocity value being representative of a harmonic mean of a plurality of local propagation velocities, exhibited by the sound waves at a respective plurality of depths from the depth of the transmitter to a depth of the receiving antenna, or from the depth of said submerged element to the depth of the receiving antenna, and as a function of
   a mean propagation angle, defined between the vertical and an effective direction of propagation of the sound wave, the mean propagation angle being determined as a function of said propagation constant and said mean velocity value of the sound wave at the depth of the transmitter or at the depth of the submerged element.

The sonar system can also comprise said transmitter, or comprise a transmitting antenna that comprises said transmitter, which is at least one in number.

The different optional features described hereinabove in relation to a method can also apply to the just-described sonar system.

The invention also relates to a sonar system comprising:
a receiving antenna configured to receive a sound wave that has been previously emitted in an underwater environment by a transmitter whose depth is known, the receiving antenna comprising several receivers adapted to output a respective plurality of reception signals upon reception of said sound wave, and
an electronic processing unit programmed to:
   determine a propagation constant of the received sound wave, as a function of said reception signal, said propagation constant being equal to the sine of a reception angle indicating the direction of reception of the sound wave with respect to the vertical, divided by a local propagation velocity of the sound waves at the depth of said receiving antenna,
   determine an effective direction of propagation of the received sound wave, as a function the product of said propagation constant and a mean propagation velocity value at the depth of the transmitter and the depth of the receiving antenna, said mean velocity value being representative of a harmonic mean of a plurality of local propagation velocities, exhibited by the sound waves at a respective plurality of depths from the depth of the transmitter to a depth of the receiving antenna,
acquire or read in a memory a data representative of the transmitter depth, and to
determine the lateral deviation with respect to the vertical, between the receiving antenna and the transmitter, as a function of the product of:
   the difference between the depth of the transmitter and the depth of the receiving antenna, and of
   the tangent of a mean propagation angle defined between said effective direction of propagation and the vertical, the mean propagation angle being determined as a function of said propagation constant and said mean velocity value of the sound wave at the depth of the transmitter.

The invention also relates to a surface or submersible, autonomous or manned vessel, provided with a sonar system as described hereinabove.

### DETAILED DESCRIPTION OF AN EXEMPLARY EMBODIMENT

The following description in relation with the appended drawings, given by way of non-limitative examples, will allow a good understanding of what the invention consists of and of how it can be implemented.

In the appended drawings:

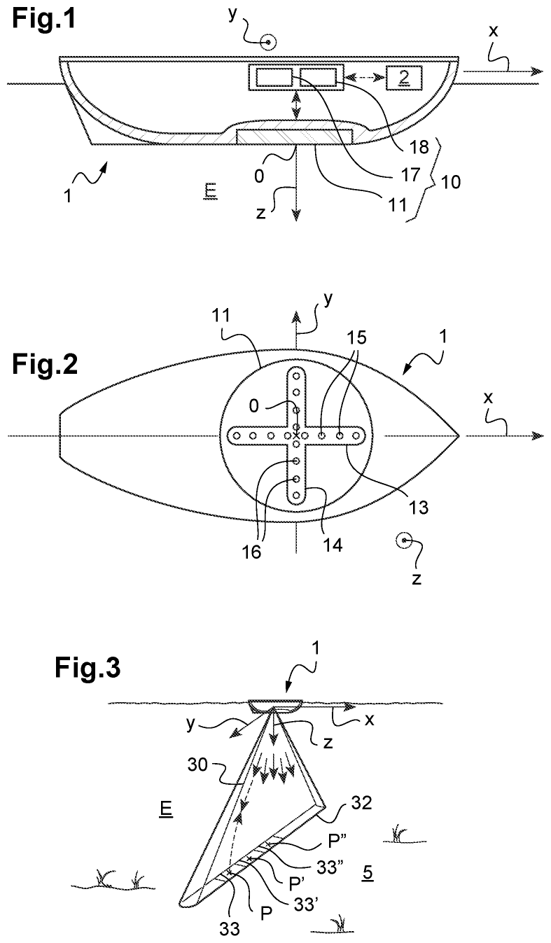

FIG. 1 schematically shows a side view of a vessel provided with a sonar system according to the invention,

FIG. 2 schematically shows a bottom view of the vessel of FIG. 1,

FIG. 3 schematically shows a sound wave beam emitted by the sonar system of FIG. 1 during a first method for surveying the topography of a seafloor,

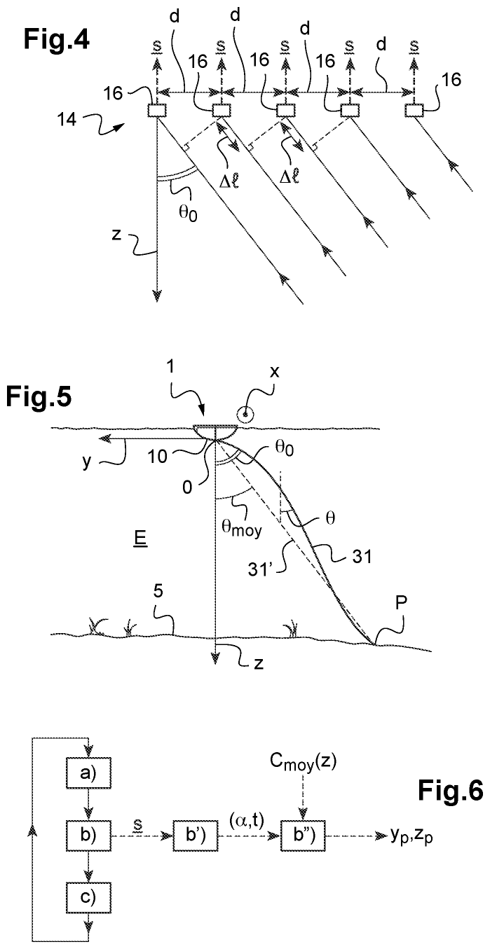

FIG. 4 schematically shows in more detail receivers of the sonar system of FIG. 1,

FIG. 5 schematically shows the path followed by a sound wave received by the receivers of the sonar system of FIG. 1,

FIG. 6 schematically shows the main steps of the first method mentioned hereinabove,

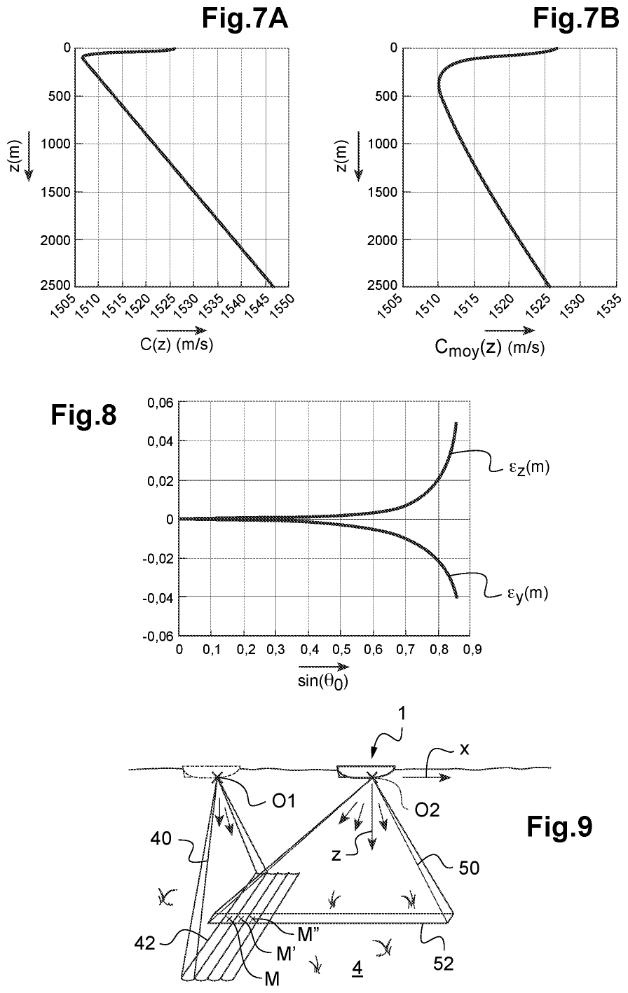

FIGS. 7A and 7B schematically show the evolution of a local propagation velocity of the sound waves in the considered underwater environment, and the evolution of a mean velocity of these waves as a function of the depth in this environment,

FIG. 8 schematically shows an error of determination relating to a depth, and to a lateral position of a point of the floor, sounded by the sonar system of FIG. 1,

FIG. 9 schematically shows sound wave beams, successively emitted by the sonar system of FIG. 1 during a second method for both surveying the topography of a seafloor and determining a mean velocity profile of the sound waves in the sounded environment,

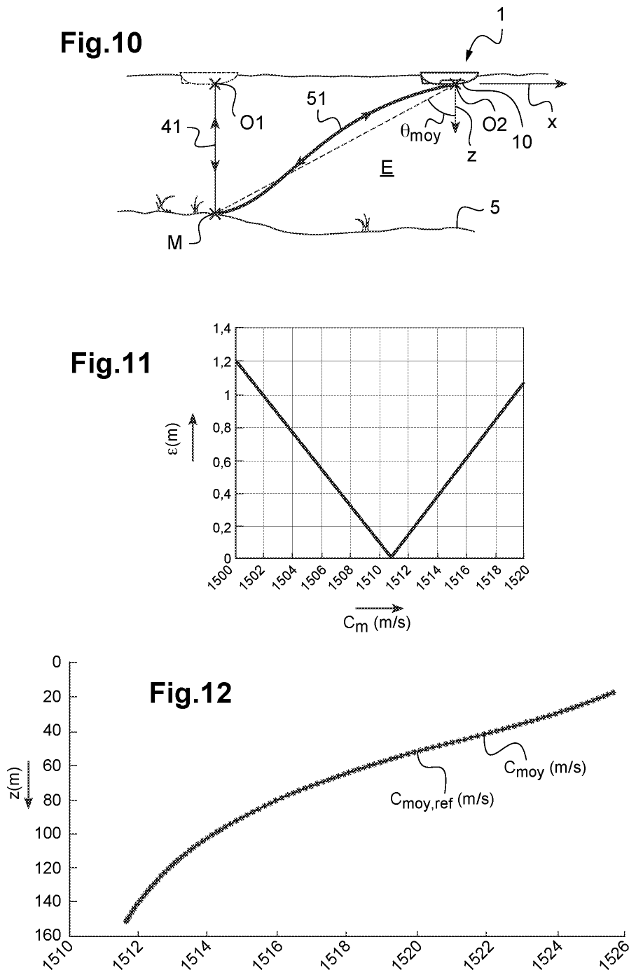

FIG. 10 schematically shows paths followed by sound waves emitted during this second method,

FIG. 11 schematically shows a deviation between two distinct estimates of a same depth, as a function of the mean velocity used to determine these two estimates,

FIG. 12 schematically shows mean velocity values determined by means of this second method, for different depths, as well as reference values for this otherwise-known velocity,

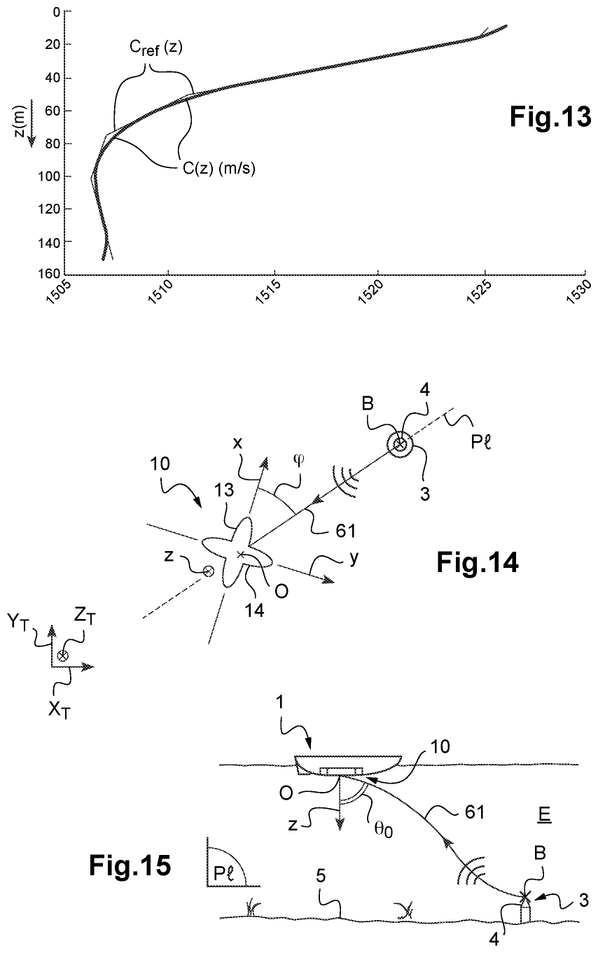

FIG. 13 schematically shows a local propagation velocity profile of the sound waves, determined during this second method,

FIG. 14 schematically shows the path of a sound wave emitted by a submerged beacon, and received by the sonar system of FIG. 1, viewed from above,

FIG. 15 schematically shows the path of the sound wave of FIG. 14, viewed from the side.

FIGS. 1 and 2 schematically show a sonar system 10 fitted on a vessel 1, herein a surface vessel.

A noticeable aspect of this sonar system 10 is that it is configured to determine positions of sounded points (depths and lateral positions of the sounded points) by taking into account, both simply and accurately, the refraction of the sound waves caused by the variations of the propagation velocity of these waves as a function of the depth.

The structure of this sonar system 10 allows different operating modes. In particular, it makes it possible to:
determine a bathymetric profile of the seafloor, i.e. to survey the topography of this floor, based on a mean velocity profile of sound in the previously surveyed underwater environment (first method, described with reference to FIGS. 3 to 8),
determine such a bathymetric profile, as well as a mean velocity profile of sound, this mean velocity profile being determined based on the bathymetric surveys themselves (second method, described with reference to FIGS. 9 to 13), and
determine a position of a beacon, or of another submerged system, with respect to the sonar system 10 (third method, described with reference to FIGS. 14 and 15).

The structure of the sonar system 10 will be first described, in relation with FIGS. 1 to 5, followed by the description of the different operating modes.

Sonar System

The sonar system 10, schematically shown in FIG. 1, comprises:
a sonar head 11, including several transducers 15, 16, as well as a control unit (not shown) for these transducers,
a unit 17 for piloting the sonar head 11, and
a unit 18 for processing the signals acquired by the sonar head.

The control unit of the transducers 15, 16 can comprise digital-to-analog and analog-to-digital converters, as well as electronic amplifiers and filters, adapted to conform electrical signals supplying the transducers or to amplify and filter reception signals sensed by some of these transducers, used in reception mode.

The transducers 15, 16 of the sonar system 10 are arranged in a cross-arrangement (called “Mills Cross” arrangement):
some transducers 15 are arranged in a line, one after the other, along a first branch of the cross, and form together a first antenna 13, whereas
the other transducers 16 are arranged one after the other along a second branch of the cross, perpendicular to the first branch thereof, and form together a second antenna 14 (FIG. 2).

The distance d between two transducers 15 located nearby the first antenna 13 is constant along this antenna, and it is the same for the transducers 16 of the second antenna 14.

The sonar head 11 is here inserted into a housing formed in the hull of the vessel 1, and is directed so that the first antenna 13 (the first branch of the Mills cross) is parallel to a longitudinal axis x of the vessel 1, the second antenna 14 being parallel to a transverse axis y of the vessel.

The vessel hull has an elongated shape along the longitudinal axis x in question, and when the vessel moves in a straight line, its progression direction coincides with this longitudinal axis x (except for the drift effects). The transverse axis y is perpendicular to the longitudinal axis x, and parallel to the vessel deck.

Here, each transducer 15, 16 of the sonar system 10 is adapted to emit sound waves in the underwater environment E surrounding the vessel, but also to receive sound waves coming from this environment (in particular sound waves reflected by the seafloor). Each of these transducers 15, 16 is hence adapted to operate both as an transmitter and as a receiver.

Each of the first and second antenna 13 and 14 has a length that is preferably higher than 20 centimetres, or even higher than 50 centimetres, thanks to what this antenna can directionally emit or receive sound waves, with a high angular resolution.

The directional nature of these antennas will be explained hereinafter, in a case where the first antenna 13 is used as a transmitting antenna and the second antenna 14 is used as a receiving antenna. In this case, the first antenna 13 emits sound waves forming a sound wave beam 30, of rather flattened shape, that:
has a large angular aperture, of several tens of degrees, in an emission plane perpendicular to the first antenna 13,
but has a reduced angular aperture (for example, lower than 5 degrees) perpendicularly to this emission plane (cf.: FIG. 3).

This sound wave beam 30 hence propagates as a fan-shaped, shallow layer, generally called “scan swath”. This emission is directional in that the emitted beam exhibits, in parallel to the transmitting antenna (hence, herein, parallel to the longitudinal axis x), said reduced angular opening. The area of the seafloor 4 reached by this beam 30 then corresponds to a thin and long strip 32, perpendicular to the transmitting antenna.

This strip 32 is consisted of several small elementary portions 33, 33′, 33″ . . . of the seafloor 4, distributed along this strip, and each centred on a point P, P′, P″ . . . . Each of these elementary seafloor portions 33, 33′, 33″ reflects a sound wave that, like an echo, is sent back towards the sonar system 10. This reflected wave is then received by the second antenna 14.

Thanks to the directional nature of the second antenna 14, the sonar system 10 is capable of discriminating two received sound waves, coming from distinct seafloor portions 33, 33′, 33″, respectively, which occupy different positions along the above-mentioned ensonified strip 32. This then allows determining the depth and the lateral position of each of these elementary positions, i.e. the depth and the lateral position of the points P, P′, P″ on which they are centred.

The directional nature of the second antenna 14 (used herein in reception mode) will be explained hereinafter, with reference to FIG. 4.

Each transducer 16 of this antenna is adapted to output a reception signal s, representative of instantaneous variations, at the position at which this transducer is situated, of a sound wave received by the antenna. When this wave is not received at a normal incidence, these reception signals s are time offset with respect to each other, by a quantity that depends directly of the reception angle θₒ, that is to say the angle of incidence according to which the sound wave is received by the antenna. Herein, the time offset Δt between two of said reception signals s is given by the following formula F1:

$$Δ t = Δ l / {C}_{0} = \frac{d . sin ( {θ}_{o} )}{{c}_{o}} = d . α . \qquad ( F1 )$$

In this formula, cₒ is the local propagation velocity of the sound waves, at the depth zₒ of the second antenna 14 (depth zₒ which is here almost null). The reception angle Go is formed between a direction perpendicular to the antenna, which here coincides with the vertical axis z, and a direction of propagation of the sound wave at the antenna 14 (that is to say where the antenna 14 is situated).

A suitable processing of the reception signals s then makes it possible to extract from these signals a component representative of the sound wave(s) received by the antenna at a given angle of reception θₒ. Waves respectively received at different angles of incidence (hence coming from points P, P′, P″ of the seafloor) can hence be discriminated from each other by the sonar system 10. The processing in question, which is a conventional beamforming processing, can for example consist in applying, to each reception signal s, a time offset proportional to the position occupied by the corresponding transducer along the antenna 14, then summing the so-offset reception signals.

As shown by formula F1 hereinabove, that is as a propagation constant α that the reception angle θₒ of the received wave intervenes in the time offset Δt between two of the reception signals s.

The propagation constant α, generally called Snell-Descartes constant, is equal to the sine of the reception angle θₒ divided by the local propagation velocity cₒ of the sound waves at the depth zₒ of the second antenna 14: α=sin(θₒ)/cₒ.

This quantity is called propagation constant because, in accordance with the so-called Snell-Descartes law, the ratio sin(θ)/c between:
the sine of the inclination angle θ, formed between the vertical and the direction of propagation of the sound wave at the considered point, and
the local propagation velocity c of the sound waves at this point, has the same value at each point of the path 31 (FIG. 5) followed by this sound wave in the underwater environment E (hence, the constant quantity sin(θ)/c is equal to sin(θₒ)/cₒ whatever the point considered along the path 31 followed by this wave).

Anyway, the processing unit 18 of the sonar system 10 is programmed to, after each emission of a sound wave beam as that described hereinabove:
acquire the different reception signals s, sensed by the transducers 16 of the second antenna 14 in response to the emission of this sound wave beam,
determine, as a function of these reception signals s, that a sound wave having a given propagation constant α has been received at a reception time, then
determine a duration τ between an emission time of the sound wave beam and the reception time of this sound wave (by the second antenna 14).

As will be seen hereinafter, the couple of data comprises this duration τ and the propagation constant α of the received wave and enables the processing unit 18 to determine the depth and the lateral position of the element of the underwater environment E having reflected said sound wave (during the propagation of this wave from the first antenna 13 to the second antenna 14).

The operating characteristics of the first and second antennas 13 and 14 have been explained hereinabove in a case where the first antenna 13 operates in transmission mode whereas the second antenna 14 operates in reception mode. However, the respective roles of these two antennas 13, 14 can be swapped with each other, the first antenna 13 then playing the role of the receiving antenna, and the second antenna 14 playing the role of the transmitting antenna.

As regards now the piloting unit 17 and processing unit 18 of the sonar system 10, they are each made by means of an electronic circuit comprising at least a processor and a memory, and, remarkably, they are programmed to execute one or several of the above-described methods. The system also comprises a GPS (“Global Positioning System”) antenna that provides an absolute position of the system in the terrestrial coordinate system, and an attitude unit comprising at least one gyroscope, which outputs signals representative of the angular movements of the system in this coordinate system (in particular, pitch and roll). The angular movements of the vessel are then compensated at the emission and the reception of the waves, by electronically modifying the directions of emission and reception as a function of the signals output by the attitude unit. Hereinafter, these movements are considered as being perfectly compensated.

First Method: Determining a Bathymetric Profile Based on a Mean Velocity Profile of Sound

As already indicated, during this first method, the topography of the seafloor situated under the vessel 1 is determined by measurements of sound wave propagation times, based on a mean velocity profile of sound in the underwater environment, c_{moy}(z).

During this first method, the transducers 15 of the first antenna 13 operate in transmission mode (this antenna is used as a transmitting antenna). The transducers 16 of the second antenna 14 operate in reception mode (the second antenna 14 is used as a receiving antenna).

This method comprises the following steps (FIG. 6):

a) emitting a train of sound waves using the first antenna 13, (the time extent of this wave train being, for example, of the order of one millisecond or a few milliseconds), as the above-described sound wave beam 30, then

b) acquiring the reception signals s, sensed by the transducers 16 of the second antenna 14 in response to the emission at step a).

The so-acquired reception signals enable the processing unit to determine the depths and lateral positions of several points P, P′, P″ of the seafloor 5 situated along a measurement line, perpendicular to the first antenna 13 (and hence here perpendicular to the longitudinal axis x of the vessel 1) and situated vertically below the vessel 1 (this measurement line corresponds to the mean line along which extends the thin strip 32 of the seafloor 5 reached by the waves 30 emitted at step a)).

Steps a) and b) are followed by a step c), during which the vessel slightly moves, in parallel to its longitudinal axis x, to a new position.

Steps a) and b) are then executed again, which makes it possible to determine the depths and lateral positions of points of the floor situated along another measurement line, slightly offset with respect to the preceding one along the longitudinal axis x.

So executing the whole steps a), b) and c) several times successively makes it possible to survey, line by line, the positions of the different points of a three-dimensional surface, representative of the topography of the considered seafloor.

The reception signals s acquired during each execution of step b) are processed during the processing steps b′) and b″).

During step b′), the processing unit 18 determines, as a function of the reception signals s acquired at step b), several couples of data (α, τ) each associated with one of the sound waves received by the second antenna 14 at step b). Each of these couples of data comprises the propagation constant α of this sound wave, as well as the duration τ separating the time of emission and time of reception of this wave.

During step b″), the processing unit 18 determines, for each of these couples of data α and τ, a depth z_{P} and a lateral position y_{P} of the small portion 33 of the seafloor 5 having reflected the considered sound wave, during the propagation thereof (round trip) form the first transmitting antenna 13 to the second receiving antenna 14. This depth z_{P} and this lateral position v_{P} locate more precisely the point P of the floor on which is centred this small seafloor portion 33.

The lateral position y_{P} of point P is the coordinate of this point along the transverse axis y (longitudinal axis y whose origin is situated at the centre O of the sonar head 11). This lateral position y_{P} is hence equal to the lateral deviation, with respect to the vertical, between the considered point P and the second antenna 14 (receiving antenna).

On the other hand, this is in fact the depth difference Δz between the point P and the sonar head 11 that is determined by the processing unit 18, based on the duration τ. But the sonar head 11 is herein situated almost at the surface of the underwater environment E, and, for the simplicity of the disclosure, the depth difference Δz is herein considered as being equal to the depth z_{P} of the sounded point. This depth z_{P}, sometimes called immersion, is equal to the distance between the point P and the surface of the underwater environment E, measured vertically.

Moreover, it is to be noted that the duration τ, between the times of emission and reception of the sound wave reflected by the point P, is equal to the time taken by this sound wave to propagate, on the way out, from the first antenna 13 to the point P, then, on the way back, from this point P to the second antenna 14. In the case in point, the respective paths followed by this wave on the way out and the way back, respectively, are identical to each other (FIG. 5). The duration τ is hence equal to the double of the propagation time t necessary for this sound wave to propagate from the considered point P to the second receiving antenna 14.

The method implemented by the processing unit 18 to determine the depth z_{P} and the lateral position y_{P} of the sounded point P is particularly remarkable in that it makes it possible to take into account the refraction of the sound waves, caused by the variations of the propagation velocity c of these waves as a function of the depth z, in a both simple and accurate manner.

This method is based on a model of propagation in which it is supposed that the received sound wave propagates:
in a straight line from the point P of the floor 5 to the second antenna 14 (and moreover also along a straight line from the first antenna 13 to the point P),
and with a mean velocity c_{moy}(z_{P}) that depends only on the depth z_{P} of the considered point P (this mean velocity being in particular independent of the inclination of the direction of propagation of this wave with respect to the vertical).

In this model, the depth z_{P} and the lateral position y_{P} of point P are hence expressed in accordance with the following formulas F2 and F3:

z_{P}=c_{moy}(z_{P})·t·cos(θ_{moy}) (F2)

y_{P}=c_{moy}(z_{P})·t·sin(θ_{moy}) (F3)

where:
the propagation time t is equal to half of this duration τ separating the times of emission and reception of the sound wave: t=τ/2, and
θ_{moy} is a mean propagation angle, defined between the vertical and an effective direction of propagation of the sound wave (mean direction of propagation of the sound wave between the point P and the second antenna 14).

In other words, the mean propagation angle θ_{moy} is defined between the vertical axis z and the straight line 31′ that links the point P to the second antenna 14. This straight line 31′ corresponds to the effective, rectilinear path that is supposed to be followed by the sound wave in this model.

With a suitable choice of the mean velocity c_{moy}(z_{P}) and the mean propagation angle θ_{moy}, it turns out that this model allows a very reliable and accurate determination of the depth z_{P} and the lateral position y_{P} of the point P having reflected the received wave.

In the case in point, the mean propagation angle θ_{moy} is determined as a function of the propagation constant α of the received sound wave (it indeed depends on the angle of reception Go at which this wave is received by the second antenna), and as a function of said mean velocity c_{moy}(z_{P}), or potentially an arithmetic mean velocity c̅(z_{P}) of the sound wave on this effective path. This arithmetic mean velocity c̅(z_{P}) is equal to the arithmetic mean of a plurality of values of the local propagation velocity c(z), exhibited by the sound waves at a respective plurality of depths z from the depth z_{P} of point P to the depth z=0 of the second antenna 14 (receiving antenna):

$$\overline{c} ( {z}_{P} ) = \frac{1}{{z}_{P}} {\int }_{0}^{{z}_{P}} c ( z ) dz . \qquad ( F4 )$$

The fact that the mean velocity c_{moy}(z_{P}) is independent of the effective direction of propagation of the sound wave significantly facilitates the processing of the acquired data and the determination of the depth and the lateral position of each point of the floor sounded by the sonar system.

In particular, the depth z_{P} as well as the value of the corresponding mean velocity c_{moy}(z_{P}) can be determined in a first instance, independently of the lateral position y_{P} of point P, which allows reducing the computation time required for this determination (the lateral position y_{P} being then determined based on the so-determined mean velocity value). This computation time reduction is all the more interesting herein since the depths and lateral positions of several points P, P′, P″ of the floor are determined, at each repetition of step b″).

The mean velocity c_{moy}(z_{P}) is equal to the harmonic mean of a plurality of values of the local propagation velocities c(z), exhibited by the sound wave at a respective plurality of depths z from the depth z_{P} of point P to the depth z=0 of the second antenna 14 (receiving antenna), i.e.:

$$\frac{1}{{c}_{moy} ( {z}_{P} )} = \frac{1}{{z}_{P}} {\int }_{0}^{{z}_{P}} \frac{1}{c ( z )} dz \qquad ( F5 )$$

It is to be noted that the quantity

$${\int }_{0}^{{z}_{P}} \frac{1}{c ( z )} dz = {\int }_{0}^{{z}_{P}} {dt}_{vert} = {t}_{vert}$$

is equal to the duration tᵥₑᵣₜ that a sound wave would take to propagate, vertically, from the depth z_{P} of the sounded point to the depth z=0 of the receiving antenna. The mean velocity c_{moy}(z_{P}) is hence equal to the depth difference z_{P} between the sounded point P and the second antenna 14, divided by this duration tᵥₑᵣₜ.

The mean propagation angle θ_{moy} is herein determined by the processing unit 18 so that its sine is equal to the product of the propagation constant α of the considered wave, multiplied by the mean velocity c_{moy}(z_{P}):

sin(θ_{moy})=α·c_{moy}(z_{P}) (F6)

The processing unit 18 is hence programmed to determine the depth z_{P} and the lateral position y_{P} of point P, either in accordance with the above formulas F2 and F3 (the mean propagation angle θ_{moy} being then determined in accordance with formula F6), or directly by means of the following formulas F7 and F8:

z_{P}=c_{moy}(z_{P})·t·{square root over (1−(α·c_{moy}(z_{P}))²)} (F7)

y_{P}=c_{moy}(z_{P})·t·(α·c_{moy}(z_{P})) (F8).

In this first method, a mean velocity profile of sound, gathering several values exhibited by the mean velocity c_{moy}(z) for a respective plurality of depths z in the underwater environment, is prerecorded in the memory of the processing unit 18.

Based on this prerecorded mean velocity profile and the measured data t=τ/2 and α, the processing unit 18 searches for the depth z_{P} that satisfies the formula F7 (for example, iteratively, as explained hereinafter). Once this depth determined, the lateral position y_{P} of point P is determined, by directly computing the quantity c_{moy}(z_{P})·t·(α·c_{moy}(z_{P})) (formula F8).

The profile of the mean velocity c_{moy}(z) is measured then recorded in the memory of the processing unit 18 during a preliminary phase of this method. During this preliminary phase, a probe, provided with a sensor adapted to measure the local propagation velocities c of the sound waves at the depth z of the sounder, is positioned successively at several depths in the underwater environment E. A profile c(z) of the local propagation velocity is hence surveyed. As an alternative, this sounder could for example be provided with sensors adapted to determine the water temperature and salinity at the depth of the sounder, these quantities then permitting to determine the local propagation velocity c(z) at the considered depth.

The profile of the mean velocity c_{moy}(z) is then determined, based on the local propagation velocity profile c(z) previously surveyed, by numerical integration, in accordance with formula F5.

FIG. 7A represents an example of local propagation velocity profile c(z) (expressed in metres per second), measured for depths (expressed in metres) comprised between 0 and 2500 metres. As can be observed in this example, the variations of the local propagation velocity c with the depth z, over this range of depths, may reach 20%. It is hence effectively desirable, as this is the case here, that these variations are taken into account during the analysis of the measured propagation times.

FIG. 7B shows the profile of the mean velocity c_{moy}(z) (in metres per second) deduced from the local propagation velocity profile c(z) of FIG. 7A. This example clearly illustrates that the variations of the mean velocity c_{moy}(z) with the depth z (expressed in metres) are more progressive than the variation of the local propagation velocity c(z) with depth. Indeed, the numerical integration operation corresponding to formula F5 has a low-pass filter effect. It eliminates certain rapid variations of the propagation velocity c(z), as well as different noises affecting the measurements of this velocity. Determining the depths of the sounded points based on the mean velocity profile c_{moy}(z) rather than based on the sound local propagation velocity profile c(z) hence makes it possible to free from these noises, and to improve the accuracy of determination of these depths.

An example of iterative method making it possible to determine the depth z_{P} of the sounded point P in such a manner that it satisfies formula F7 will now be described.

This method comprises a step of determining an estimate z_{P,j} of the depth z_{P}, and an estimate c_{moy},i of the corresponding mean velocity c_{moy}(z_{P}). This estimation step is executed several times successively, iteratively.

During the i^{th} execution of this step, a new estimate c_{moy},i of the mean velocity is determined, based on a preceding estimate z_{P,j-1} of the depth z_{P}, and based on the prerecorded mean velocity profile, in accordance with the following formula F9:

c_{moy,i}=c_{moy}((z_{P,i-1}) (F9).

A new estimate z_{P},j of the depth z_{P} is then determined by replacing the mean velocity c_{moy}(z_{P}) by its estimate c_{moy},j, in formula F7:

z_{P,i}=c_{moy,i}·t·\sqrt{1−(α·c_{moy,i})²} (F10)

This iterative method begins for example from the initial estimate c_{moy,1}=c_{moy}(z=⁰) of the mean velocity.

The successive executions of the estimation step in question stop when a deviation |c_{moy,j+1}−c_{moy,i}| between two successive estimates c_{moy,i+1} and c_{moy,i} of the mean velocity becomes lower than a given threshold. In practice, this threshold can be comprised for example between 1 metre per second and 1 millimetre per second. As an alternative, the successive executions of this estimation step could be stopped when a relative deviation between two successive estimates z_{P,i+1} and z_{P,i} of the depth z_{P} becomes lower than a given required accuracy.

FIG. 8 schematically shows an error ε_{z}, representative of a deviation between the real depth of the sounded point P and the depth z_{P} determined based on the single-layer model of the underwater environment E described hereinabove (a model in which this environment is represented by an effective homogeneous layer, in which the propagation is rectilinear). This error ε_{z} is represented as a function of the sine of the reception angle θₒ, for a depth of the sounded point of 200 metres.

An error ε_{y}, representative of a deviation between the real lateral position of a sounded point P and its lateral position y_{P} determined based on this model is also shown in FIG. 8.

The two errors ε_{z} and ε_{y} shown in this figure have been determined by numerical simulation, based on the propagation velocity profile c(z) of FIG. 7A. For that purpose, the respective paths followed by sound waves, emitted with different initial directions of propagation, have been determined by taking into account the gradual refraction (layer by layer), down to a depth of 200 metres. This simulation has permitted to determine the propagation time t, which would have been measured in practice for a wave following such a path, then to deduce therefrom the depth z_{P} and the lateral position y_{P}, which would have been determined in practice by the processing unit based on this propagation time t. The error ε_{z} is equal to the deviation between the depth z_{P} coming from this simulation of a depth measurement and the reference depth that is used, 200 metres. The error ε_{y} is equal to the deviation between the lateral position y_{P}, as it would have been determined by the processing unit, and the lateral position coming from the plot of the considered sound wave path, made gradually, layer by layer. This simulation has been made for values of the reception angle θₒ comprised between 0 and 60 degrees (and hence for values of sin(θₒ) comprised between 0 and about 0.85).

As can be seen in this figure, even when the received sound waves are very inclined with respect to the vertical (situation in which their trajectories are strongly bent by refraction), the errors ε_{z} and ε_{y} remain extremely small: these errors remain lower than 5 centimetres, whereas the sounded depth is 200 metres. For reception angles lower than 30 degrees, these errors are even lower than 3 millimetres.

It is hence observed in this example that the determination method implemented by the processing unit 18 produces very reliable and accurate depth and lateral position values, while significantly simplifying the numerical determination of these quantities with respect to a determination that would be based on a point-by-point plotting of the path followed by the wave.

The fact that this single-layer model produces accurate results can be explained in part by the following theoretical arguments.

First, it is known in the field of seismic measurements that the seismic wave propagation time t between a source point and a receiver is given, with a good approximation, by the following formula F11:

t²=tᵥₑᵣₜ²+y²/c_{RMS}² (F11)

where:
y denotes the lateral deviation, with respect to the vertical, between the considered source point and the receiver,
tᵥₑᵣₜ is the time that a seismic wave would take to propagate, vertically, from the depth z of the considered source point to that of the receiver (quantity that has already been mentioned hereinabove, during the presentation of formula F5), and
c_{RMS} is a root mean square velocity, along the path followed by the seismic wave:

$${c}_{RMS}^{2} = \frac{1}{t} {\int }_{0}^{t} {c}^{2} ( t ) dt .$$

This formula (mentioned for example in Chapter 5 of “Geophysical Signal Processing”, E. A. Robinson, T. S. Durrani and L. G. Peardon, Prentice Hall, 1986, ISBN 0133526674) is usually used in the field of seismic measurements to temporally align different received signals, to be thereafter able to sum these signals to improve the signal-to-noise ration by mean effect.

In the case in point, the time of “vertical” propagation, tᵥₑᵣₜ, is equal to the depth z, divided by the harmonic mean c_{H}(Z) of the local propagation velocities c, between this depth z and the surface:

$${t}_{vert} = \frac{z}{{c}_{H} ( z )} = z . {\int }_{0}^{z} \frac{1}{c ( {z}^{′} )} {dz}^{′} .$$

Moreover, in an underwater environment, unlike in a geologic environment, the harmonic mean velocity c_{H} is very close to the root mean square velocity c_{RMS}. For example, in the case of the underwater environment E considered herein, whose propagation velocity profile is plotted in FIG. 7A, the difference between the harmonic mean velocity c_{H} and the root mean square velocity c_{RMS} remains lower than 2 centimetres par second, for the whole range of depths considered. Moreover, it is to be noted that, in this underwater environment, the harmonic mean velocity c_{H} and the arithmetic mean velocity c̅ are also very close to each other, because they are linked to the root mean square velocity c_{RMS} by the following relation: C_{RMS}²=c_{H}. c̅ (the root mean square velocity is equal to the geometric mean of the harmonic mean velocity and of the arithmetic mean velocity).

For measurements made in a liquid medium, we have hence, with a good approximation:

t²=(z²+y²)/c_{H}².

Now, in the single-layer propagation model that has been presented hereinabove, the propagation time t is linked to the depth z_{P} and the lateral position y_{P} of the sounded point by the following relation:

t²=(z_{P}²+y_{P}²)/c_{moy}²

where c_{moy} is the effective mean velocity in the single layer that is considered.

For this propagation model to be the more representative possible of the real physical link between the propagation time t and the coordinates z_{P}, y_{P}, it must indeed be parameterized by choosing, for the mean velocity c_{moy}(z_{P}), the above-mentioned harmonic velocity c_{H}, i.e., as already indicated:

$${c}_{moy} ( {z}_{P} ) = {c}_{H} ( {z}_{P} ) = {( \frac{1}{{z}_{P}} {\int }_{0}^{{z}_{P}} \frac{1}{c ( z )} dz )}^{- 1} .$$

Moreover, by extending and modifying certain results presented in “Approximate Methods For Ray Tracing”, M. J. Daintith, SaclantCen Conference proceedings No 5, September 1971, the inventor has demonstrated the following results: developing the first order propagation equations in ε(z), where c(z)=c̅ (1+E(z)), leads to the following formulas:

$${z}_{P} = \overline{c} t \sqrt{1 - {α}^{2} {\overline{c}}^{2}} ( 1 - \overline{{ɛ}^{2}} \{ 1 - \frac{{A}^{2}}{2} + \frac{3 {A}^{4}}{2} \} )$$

and

y_{P}=αc̅²t(1+ε̅²̅(2A²−1))

with ac̅=sin θ_{moy}, A=tan θ_{moy},

$$\overline{{ɛ}^{2}} ( z ) = \frac{1}{{z}_{P}} {\int }_{0}^{{z}_{P}} {ɛ}^{2} ( z ) dz .$$

By then neglecting the terms in A²ε̅²̅ and A⁴ε̅²̅ in these equations, and using the fact that, at the first order, the mean harmonic velocity is written c_{H}=c̅[1−ε̅²̅], the following approximation formulas are obtained:

z_{P}=(c_{H}t)\sqrt{1−a²c̅²}, y_{P}=(c_{H}t)αc̅ and D=\sqrt{z_{P}²+y_{P}²}=c_{H}t.

These last equations show that the mean propagation angle to be used is, with a very good approximation, defined by the following formula F12:

sin(θ_{moy})=α·c̅(z_{P}) (F12).

By approximating the arithmetic mean velocity c by the harmonic mean velocity c_{H} in formula F12, the following relation is obtained

sin(θ_{moy})=α·c_{H}

based on which the processing unit 18 determines the depth and the lateral position of the sounded points. The validity of the approximation sin(θ_{moy})=α.c_{H}, shown hereinabove from a theoretical point of view, is moreover justified, a posteriori, by the accuracy of the results that can be obtained therewith (cf.: FIG. 8).

The above computations however show that the approximation of formula F12, sin(θ_{moy})=α.c̅(z_{P}), is even better.

As an alternative, the processing unit 18 could hence be programmed in such a manner to determine the depth z_{P} and the lateral position y_{P} of each sounded point P in accordance with the following formulas F13 and F14:

z_{P}=c_{moy}(z_{P})·t·{square root over (1−(α·c(z_{P}))²)} (F13)

y_{P}=c_{moy}(z_{P})·t·(α·c̅(z_{P})) (F14).

In the first method described hereinabove, the positions of different points of a three-dimensional surface, representative of the topography of the seafloor 5, are surveyed line-by-line, thanks to the longitudinal displacement of the vessel 1.

As an alternative, the vessel could keep the same position all along this method, the three-dimensional surface in question being then surveyed by varying the inclination of the emitted sound wave beam 30, between one emission and the following one (that is to say between two successive executions of step a)), instead of systematically emitting this beam vertically.

As another alternative, instead of surveying the positions of several points of the floor covering a whole region of the latter, it could be provided to survey the depth and/or the lateral position of only one point of the floor.

On the other hand, this first method can be used to determine the depths and/or lateral positions of submerged elements others than portions of the seafloor, such as a fish, a fish shoal, or a part of a fish shoal (this method is hence not only a method for determining a bathymetric profile). The depths and/or lateral positions of such elements are determined in the same way as what has been explained hereinabove for a point of the seafloor.

Second Method: Determining a Bathymetric Profile, and Determining a Mean Velocity Profile of Sound Based on the Bathymetric Surveys Themselves

In this second method, as in the first method, the depths of different points of the seafloor are determined, from propagation time measurements, based on the above-described single-layer model (one-effective-layer model).

But herein, unlike in the first method, the mean velocity profile c_{moy}(z) in the underwater environment E, which intervenes during the analysis of the propagation time measurements, is not prerecorded in a memory of the sonar system 10 (it is not measured previously to the depth survey).

In this second embodiment, the depth of a given point of the seafloor is determined, without previous knowledge of the mean velocity profile, thanks to a comparison of at least two distinct propagation time measurements between the sonar system 10 and the sounded point, these two measurements being made for two distinct positions of the sonar system 10 (and hence for two different inclinations of the received sound waves).

The comparison of these two propagation times further makes it possible to determine the mean velocity value, c_{moy}(z_{M}), at the depth z_{M} of the considered point M.

FIGS. 9 and 10 schematically show the way a series of propagation time measurements are taken, which permit, by comparison of these measurements with each other, to determine:
the respective depths of several points of the floor, M, M′, M″, here situated along a measurement line parallel to the longitudinal axis x of the vessel 1, and
the corresponding values of the mean velocity c_{moy} in this environment.

During this series of measurements, for a first position O1 of the vessel 1, the first antenna 13 emits a transverse sound wave beam 40, such as the beam 30 described hereinabove with reference to FIG. 3. This beam is herein emitted vertically, below the sonar system 10. The mean plane defined by this beam, parallel to the transverse axis y, extends vertically below the sonar system 10. This beam reaches a thin strip 42 of the seafloor, perpendicular to the longitudinal axis x. In response to this emission, the second antenna 14 receives the sound waves that have been reflected by the elements of this strip 42, and the transducers 16 of the second antenna 14 acquire the corresponding reception signals. Based on these signals, the processing unit 18 determines in particular a first propagation time t_{M,1} taken by one of these waves to propagate from the sonar system 11 to a point M of the floor situated vertically below this system (in the case in point, this sound wave propagates along a vertical and rectilinear path 41, with a first propagation constant α_{M,1} that is hence null).

The vessel 1 then moves, in parallel to its longitudinal axis x, to other intermediate positions. At each of these positions, the sonar system 11 determines a propagation time t_{M′,1}, t_{M″,1}, . . . between the sonar system 11 and a point M′, M″, . . . of the floor situated vertically below this system, as explained hereinabove for the first position O1.

The vessel 1 then moves to a second position O2. At this second position, the second antenna 14 transmits a longitudinal sound wave beam 50 that propagates as a shallow layer whose mean plane is parallel to the longitudinal axis x (since the second antenna 14 extends perpendicularly to this axis). This beam hence reaches a thin strip 52 of the seafloor, which is this time parallel to the longitudinal axis x (instead of being perpendicular thereto). In response to this emission, the first antenna 13 receives the sound waves that have been reflected by the elements of this strip 52, and the transducers 15 of the first antenna 13 acquire the corresponding reception signals. Based on these signals, the processing unit 18 then determines
second propagation times t_{M,2}, t_{M′,2}, t_{M″,2}, . . . taken by the different received sound waves, to propagate from the sonar system 11 to the points M, M′, M″ of the floor sounded thanks to the emission of this longitudinal beam 50 (points that are distributed along the above-mentioned measurement line, parallel to the longitudinal axis x), and
second propagation constants α_{M,2}, α_{M′,2}, α_{M″,2}, . . . , which are the propagation constants of these sound waves.

The depth of each point M, M′, M″ situated along this measurement line is hence sounded:
a first time (from the second position O1), by means of a sound wave propagating vertically, then
a second time (from the second position O2), by means of a sound wave whose direction of propagation is inclined with respect to the vertical (during this second measurement, the path 51 followed by the sound wave that sounds the position of point M is hence bent by the refraction, as shown in FIG. 10).

The depth of this point is then determined by the processing unit 18 by comparing this first measurement and this second measurement with each other.

For that purpose, the processing unit 18 first determines the mean velocity value, c_{moy}(z_{M}), at the depth z_{M} of the considered point M, as a function of the first propagation time t_{M,1} the second propagation time t_{M,2} and the second propagation constant α_{M,2}.

The processing unit 18 then determines the depth z_{M} of the point M, based on this mean velocity value.

More precisely, the processing unit 18 determines the mean velocity value c_{moy}(z_{M}) as being the value for which a root mean square deviation ε² between:
a first estimate z_{M,1} of the depth z_{M}, determined based on the first propagation time t_{M,1}, and
a second estimate z_{M,2} of the depth z_{M}, determined based on the second propagation time t_{M,2} and the second propagation constant α_{M,2},

is a minimum (or at least lower than a threshold, for example lower than 10 centimetres), each of these two estimates being determined on the basis of this same mean velocity value c_{moy}(z_{M}). So:

$${c}_{moy} ( {z}_{m} ) = {argmin}_{{c}_{m}} ( {ɛ}^{2} ) = {argmin}_{{c}_{m}} ( {[ {z}_{M , 1} ( {t}_{M , 1} , {c}_{m} ) - {z}_{M , 2} ( {t}_{M , 2} , {α}_{M , 2} , {c}_{m} ) ]}^{2} ) . \qquad ( F15 )$$

The first estimate z_{M,1} and the second estimate z_{M,2} are each determined based on the above-described single-layer model, in accordance with formulas F2 and F6, or in accordance with formula F7 i.e.:

z_{M,1}=cₘ·t_{M,1} et z_{M,2}=cₘ·t_{M,2}·\sqrt{1−(α_{M,2}·cₘ)²}.

In the particular embodiment of the second method that is described herein, the minimization of the root mean square deviation ε² (which here amounts to nullify this deviation) then leads to determine the mean velocity c_{moy}(z_{M}) at point M, in accordance with the following formula F16:

$${c}_{moy} ( {z}_{M} ) = \frac{1}{{α}_{M , 2}} \cdot \sqrt{1 - {( \frac{{t}_{M , 1}}{{t}_{M , 2}} )}^{2}} . \qquad ( F16 )$$

The processing unit 18 can for example determine the mean velocity c_{moy}(z_{M}) in accordance with formula F16, or by a numerical research for the value of cₘ that minimizes the root mean square deviation ε² (in accordance with formula F15).

It is to be noted that, in this method, among the different couples of data (α_{M,2}, t_{M,2}), (α_{M′,2}, t_{M′,2}), (α_{M″,2}, t_{M″,2}), . . . , respectively associated with the different waves received by the first antenna 13 from the second position O2, the one (α_{M,2}, t_{M,2}) that corresponds to the sound wave that has been reflected by the same point M as that which has been sounded from the first position O1 must be identified (since this method is based on the comparison of two distinct estimates of the depth of a same point). For that purpose, the processing unit 18 can for example select among these couples of data the one for which a lateral deviation x_{M}, determined as a function of the considered couple of data (α, τ) (for example, according to the formula x_{M}=c_{moy}²·t·α), is the closest to the distance separating the first position O1 from the second position O2 (distance that is known, for example, thanks to a locating system 2, such as a GPS system or a log fitted on the vessel 1).

FIG. 11 schematically shows the value of the deviation ε between the two depth estimates z_{M,1} and z_{M,2} (expressed in metres), as a function of the variable to be adjusted cₘ (in metres per second), in a situation in which the seafloor is flat, situated at a depth of 200 metres. The values of the first and second propagation times and of the second propagation constant, from which these depth estimates z_{M,1} and z_{M,2} are derived, are herein obtained by numerical simulation, as explained hereinabove about FIG. 8.

As can be seen in this figure, in this situation, the smallest value of the deviation c is obtained for cₘ=1510.8 metres per second. Now, in the considered underwater environment E, the value of the mean velocity c_{moy} at a depth of 200 metres is of 1510.7 metres per second. This shows that this method actually permits, by comparing several bathymetric measurements, to determine a value of the mean velocity extremely close to the real value of this mean velocity in the sounded environment E.

FIG. 12 moreover shows several values of mean velocity c_{moy} determined from the bathymetric surveys themselves (these values, expressed in metre per second, are plotted on this graph as stars), for different depths z (expressed in metres) comprised between 10 and 150 metres, and, for the same depths, reference values of the mean velocity, c_{moy ref} (represented as a continuous line). The mean velocity values, derived from the bathymetric surveys themselves, are determined from propagation time obtained as above by numerical simulation, in a situation in which the depth of the seafloor varies progressively, from 10 metres to 150 metres, over a length of 3 kilometres. This figures shows again that the mean velocity values deduced from the bathymetric surveys are very closed to reference values of this velocity (these reference values c_{moy,ref} being obtained by integration of a reference profile of the local propagation velocity c_{ref}(z)).

The second method hence makes it possible to obtain in real time bathymetric measurements and an estimate of the mean velocity value for each measured depth. A mean velocity profile is hence obtained from the mean velocity values obtained for different depths.

It may further be provided, during this second method, that the processing unit 18 determines a local propagation velocity profile of the sound waves, c(z), from the mean velocity profile c_{moy}(z) determined as explained hereinabove (i.e. from several bathymetric surveys compared with each other).

For that purpose, the local propagation velocities c(z), at the depth z, can for example be determined in accordance with the following inversion formula F17 (deduced for formula F5):

$$c ( z ) = \frac{{c}_{moy}^{2} ( z )}{{c}_{moy} ( z ) - z . {dc}_{moy} ( z ) / dz} \qquad ( F17 )$$

FIG. 13 schematically shows a local propagation velocity profile c(z) (expressed in metres per second), determined that way, for different depths z (expressed in metres) comprised between 10 and 150 metres. For these same depths, this figure also shows a reference profile of the local propagation velocity c_{ref}(z) (this reference profile gathers the local propagation velocity values, as they would have been measured by a sounder placed successively at different depths, for example; this profile is here known for only a few depths distributed in the range from 10 to 150 metres, and hence exhibits a broken line profile, with a piecewise constant derivative). These two profiles are very closed to each other (the relative derivation between these two profiles remains lower than 0.5 per thousand), which shows that this method of determination of the local propagation velocity profile c(z), by comparison of bathymetric measurements, gives reliable and accurate results.

The local propagation velocity profile c(z) is hence obtained, in real time, at the same time as the bathymetric surveys themselves.

However, it is to be noted that, in formula F17, the derivative dc_{moy}(z)/dz present at the denominator can have for effect to amplify slight noises or numerical errors potentially affecting the mean velocity profile c_{moy}(z).

To remedy thereto, the processing unit 18 can, for example, implement a regularization procedure such as those described hereinafter.

For example, supposing a constant local propagation velocity in the interval [z₁, z₂], denoted c, the mean velocity measurements c_{moy}(z₁) at z₁ and c_{moy}(z₂) at z₂ give:

$$\frac{1}{c} = \frac{1}{{z}_{2} - {z}_{1}} ( \frac{{z}_{2}}{{C}_{moy} ( {z}_{2} )} - \frac{{z}_{1}}{{C}_{moy} ( {z}_{1} )} ) .$$

More generally, it can be supposed that the local propagation velocity profile c(z) varies linearly over the considered depth interval [z₁, z₂]: c(z)=c₁+g(z−z₁), for z∈[z₁,z₂].

The values of the two variables c1 and g, which characterize this velocity profile, are then determined by the processing unit as being the values that minimize the following cost function FC:

$$FC = {\sum }_{i} \vert ( \frac{{z}_{i}}{{c}_{moy} ( {z}_{i} )} - \frac{{z}_{1}}{{c}_{moy} ( {z}_{1} )} ) - \frac{1}{g} log ( \frac{{c}_{1} + g ( {z}_{i} - {z}_{1} )}{{c}_{1}} ) \vert$$

where the sum Σᵢ relates to the different depths zᵢ of the interval [z₁, z₂] for which the mean velocity c_{moy}(zᵢ) has been determined.

Different alternatives may be applied to the just-described second method.

First, the measurement of the first propagation time t_{M,1} could be made by means of a wave whose direction of propagation is inclined with respect to the vertical (instead of propagating vertically, as this is the case in the exemplary embodiment described hereinabove). In this last case, the mean velocity value c_{moy}(z_{M}) at point M is determined by taking into account a first propagation constant α_{M,1} with which this first wave propagates, in addition to taking into account the first and second propagation times t_{M,1}, t_{M,2} and the second propagation constant α_{M,2}. Within the framework of this alternative, the first estimate z_{M,1} of the depth z_{M} is determined for example as being equal to z_{M,1}=cₘ·t_{M,1}·\sqrt{1−(α_{M,1}·cₘ)²} (instead of being determined as a function of only cₘ and t_{M,1}). As regards the mean velocity value c_{moy}(z_{M}), it is determined, here again, in such a way as to minimize the root mean square deviation ε² (or at least in such a way as to make it lower than a given threshold).

As another alternative, it could be provided, in this second method, to measure propagation times t_{M,i} between the sonar system and a same point M of the seafloor, for more than two distinct positions of the sonar system. For each of these positions, Oᵢ, the sonar system then determines the propagation constant α_{M,i} of the sound wave having sounded the depth of point M, in addition to the above-mentioned propagation time t_{M,i}.

The mean velocity value c_{moy}(z_{M}) at point M is then determined by the processing unit 18 as being the value for which an overall deviation ε′, representative of the dispersion of a set of estimates z_{M,i} of the depth z_{M}, each determined based one of the couples (α_{M,i}, t_{M,i}) measured from one of said positions Oᵢ, is minimum (or lower than the above-mentioned threshold).

The overall deviation ε′ can for example be equal to the standard-deviation or to the variance of this set of estimates, or to the sum of the root mean square deviations between these estimates, taken two-by-two. Each of these estimates is determined, as hereinabove, based on the above-described single-layer model (and hence, for example, in accordance with formula F7).

By way of example, if three propagation time measurements t_{M,1}, t_{M,2}, t_{M,3} are made to locate the point M, for three distinct positions of the sonar system, this overall deviation ε′ can be defined as follows:

ε′=[z_{M,1}(t_{M,1},α_{M,1},cₘ)−z_{M,2}(t_{M,2},α_{M,2},cₘ)]²+[z_{M,2}(t_{M,2},α_{M,2},cₘ)−z_{M,3}(t_{M,3},α_{M,3},cₘ)]²+[z_{M,3}(t_{M,3},α_{M,3},cₘ)−z_{M,1}(t_{M,1},α_{M,1},cₘ)]².

Third Method: Determining the Position of a Submerged Beacon

In this third method, a transmitter 4 of a submerged beacon 3 emits a sound wave, that is then received by the sonar system 10 (FIGS. 14 and 15).

The processing unit 18 of the sonar system 10 then determines a position of this beacon 3, with respect to the sonar system 10, based on:
the propagation constant α of this wave, measured at its reception by the sonar system, and, according to the considered embodiment, based in addition on
a propagation time t_{B} taken by this wave to propagate from this transmitter 4 to the sonar system 10.

It is to be noted that the sound wave in question herein performs a one-way travel, whereas the sound waves emitted in the first and second methods perform round-trip travels (like an echo). The propagation time t_{B} is hence equal to the duration separating the time of emission of this wave, and the time of reception of this wave (instead of being equal to half of this duration).

Anyway, the position of this beacon 3 is here again determined based on the above-described single-layer propagation model, as a function of the profile of the mean velocity c_{moy}(z). In this third method, this profile is prerecorded in the memory of the processing unit 18.

On the other hand, in this third method, the first and second antennas 13 and 14 are both used in reception mode.

The path 61 followed by the emitted sound wave between the beacon 3 and the sonar system 10 is situated in a vertical plane of propagation PI that passes through the centre B of the transmitter 4 and through the centre O of the sonar head 11.

The sound wave propagation direction, at point O of reception of this wave, is located by:
it reception angle θₒ, formed, in the plane of propagation PI, between this direction of propagation and the vertical z, and by
a pointing angle φ, formed between the plane of propagation PI and the plane (x,y) (vertical plane parallel to the longitudinal axis x).

The propagation constant α of the sound wave is, as hereinabove, equal to the sine of the reception angle θₒ, divided by the local propagation velocity cₒ of the sound waves at the depth of the receiving antennas, 13 and 14. The processing unit 18 is programmed to determine, in particular, the propagation constant α, based on the reception signals sensed by the transducers 15, 16 of the first antenna 13 and of the second antenna 14 during the reception of this sound wave.

In the case in point, the time offset Δtₓ between two reception signals output by two transducers 15 of the first antenna 13 separated by a distance dₓ is given by Δtₓ=dₓ·α·cos(φ). Comparably, the time offset Δt_{y} between two reception signals output by two transducers 16 of the first antenna 14 separated by a distance d_{y} is given by Δt_{y}=d_{y}·α·sin(φ). The propagation constant α of the received sound wave, and the quantities α·cos(q) and α·sin(q) can then be obtained based on these time offsets. The propagation constant is determined, for example, by computing the quantity \sqrt{(Δtₓ/dₓ)²+(Δt_{y}/d_{y})²}.

In a first embodiment of this third method, the processing unit 18 determines the position of the centre B of the transmitter 4, with respect to the sonar system, based on both the propagation constant α and the propagation time t_{B}.

This first embodiment is adapted to a situation in which the beacon 3 and the sonar system 10 share a same common time reference, which enables the processing unit 18 to determine the propagation time t_{B} (the sonar system and the beacon each having for example a clock, these two clocks being accurately synchronized with each other).

In this first embodiment, the processing unit 18 determines coordinates x_{B}, y_{B}, z_{B}, that locate the beacon 3 in the coordinate system x,y,z linked to the sonar system 10, as follows.

Firstly, the depth z_{B}, and the corresponding mean velocity, is determined by solving the following equation:

z_{B}=c_{moy}(z_{B})·t_{B}·{square root over (1−(α·c_{moy}(z_{B}))²)}.

Then, the “horizontal” coordinates x_{B}, y_{B}, are determined in accordance with the following formulas:

x_{B}=c_{moy}²(z_{B})·t_{B}·α·cos(φ) and y_{B}=c_{moy}²(z_{B})·t_{B}·α·sin(φ).

The processing unit 18 can further be programmed to determine a position of the beacon 3 in a coordinate system in which the beacon is fixed, as the terrestrial coordinate system X_{T}, Y_{T}, Z_{T}. For that purpose, the processing unit 18 acquires a position of the vessel 1, located in the terrestrial coordinate system, by means of the locating system 2 fitted on this vessel, the vessel 1 being situated at the same position as during the reception of the sound wave emitted by the beacon 3. The position of the beacon 3 is then determined as a function of the position of the vessel 1 in the terrestrial reference system, and of the position (x_{B},y_{B},z_{B}) of the beacon with respect to the sonar system 10.

In a second embodiment of this third method, the processing unit 18 determines the lateral position (x_{B},y_{B}) of the centre B of the transmitter 4, with respect to the sonar system 10, based on the propagation constant α of the received sound wave, and a previously known depth z′_{B} of the beacon.

This depth z′_{B} is known by the processing unit 18, for example, because data representative of this depth have been emitted from the beacon 3 to the sonar system 10 through the sound wave emitted by the beacon.

This second embodiment advantageously makes is possible to determine the position of the beacon 3, even if the sonar system 10 and this beacon 3 do not share a common time reference.

The coordinates x_{B}, y_{B} that locate the lateral position of the centre B of the transmitter 4 in the horizontal plane (x,y) are each determined as a function of the product of:
the difference between the transmitter 4, z′_{B}, and the depth of the sonar head, herein considered as null, and of
the tangent of the mean propagation angle θ_{moy}, that has been defined hereinabove (during the description of the first method).

The tangent tan(θ_{moy}) of this mean propagation angle θ_{moy} is determined as a function of the propagation constant α of the received wave and of the mean velocity c_{moy}(z′_{B}) at the depth z′_{B} of the transmitter 4:

tan(θ_{moy})=c_{moy}(z′_{B})·α/{square root over (1−(c_{moy}(z′_{B})·α)²)}

In this second embodiment, the processing unit 18 then determines the coordinates x_{B}, y_{B} in accordance with, for example, the following formulas:

x_{B}=z′_{B}·c_{moy}(z′_{B})·α/{square root over (1−(c_{moy}(z′_{B})·α)²)}·cos(φ)

y_{B}=z′_{B}·c_{moy}(z′_{B})·α/{square root over (1−(c_{moy}(z′_{B})·α)²)}·sin(φ).

As an alternative, the tangent of the mean propagation angle θ_{moy} could however be determined as a function of the arithmetic mean velocity c̅(z′_{B}), instead of being determined as a function of the (harmonic) mean velocity c_{moy}(z′_{B}). In this case, the tangent of the mean propagation angle θ_{moy} is determined in accordance with the following formula:

tan(θ_{moy})=c̅(z′_{B})·α/{square root over (1−(c̅(z′_{B})·α)²)}.

Moreover, as in the first embodiment, the processing unit 18 can further be programmed to determine a position of the beacon 3 in a coordinate system in which the beacon is fixed, such as the terrestrial coordinate system X_{T}, Y_{T}, Z_{T}.

It is to be noted that this third method is herein applied to the location of a submerged beacon, but it may also be applied to the determination of the position of another submerged system emitting sound waves, such as a submarine distinct from the above-mentioned vessel 1, for example, and whatever the considered embodiment.

Different alternatives may be applied to the above-described methods and sonar system.

First, the sonar system could be fitted on a submersible vessel, instead of a surface vessel, whether this vessel is autonomous or manned.

In this case, this in not directly the depth of a point of the seafloor, or the depth of the transmitter of the beacon to be localized that is determined, but a difference Δz=z_{P}−zₒ between the depth z_{P} of this point of the floor (or of this transmitter) and the depth zₒ of the receiving antenna of the sonar system 10.

The first, second and third methods are then executed by the piloting unit 17 and processing unit 18 fully similarly to what has been described hereinabove, but by determining the mean velocity c_{moy}(z_{P}) in accordance with the following formula:

$$\frac{1}{{c}_{moy} ( {z}_{P} )} = \frac{1}{( {z}_{P} - {z}_{o} )} {\int }_{0}^{{z}_{P}} \frac{1}{c ( z )} dz \qquad ( {F5}^{′} )$$

and, optionally, by determining the arithmetic mean velocity in accordance with the following formula:

$$\overline{c} ( {z}_{P} ) = \frac{1}{( {z}_{P} - {z}_{o} )} {\int }_{0}^{{z}_{P}} c ( z ) dz \qquad ( {F4}^{′} )$$

In other hand, the single-layer model used to determine the position of the sounded point or of the transmitter beacon could be parameterized slightly differently from what has been shown hereinabove. Thus, by way of example, the mean propagation angle θ_{moy} could exhibit a slight relative deviation with respect to the (optimum) case presented hereinabove, for which sin(θ_{moy})=α·c_{moy}(z_{P}), (or, as an alternative, for which sin(θ_{moy})=α·c(z_{P})). It is however preferable that this relative deviation remains lower than one per thousand (i.e. 0.001), because it makes it possible to keep, for the depths and lateral deviations determined by the processing unit, high accuracies, comparable to what has been presented hereinabove.

Moreover, as already indicated, the sonar system could have a simpler structure: it could for example include, instead of two complete multi-sensor linear antennas whose receivers (for example, at least four in number) are spaced apart by λ/2 (where λ is the mean wavelength of the emitted sound waves), arranged in a “Mills cross”, a lacunar receiving system (whose receivers are spaced apart by more than λ/2) composed a minima of 3 receivers that are not aligned with each other. In this case, the angular ambiguity can be solved (i.e. cleared up), by way of example, by emitting wide-band signals (whose spectral content extends over a wide frequency band).

As another alternative, the command, piloting and processing units could be made as a same electronic unit, or, on the contrary, be subdivided into a greater number of modules than what has been described hereinabove.

1. A method for determining depth difference (z_{P}, Δz; z_{M,1}, z_{M,2}, z_{M}; z_{B}), or a lateral deviation (y_{P}; x_{M}; X_{B}, y_{B}) with respect to the vertical, between two points of an underwater environment (E), the method comprising the following steps:
emitting a sound wave in the underwater environment (E) using at least one transmitter,
receiving said sound wave using a receiving antenna comprising several receivers, said receivers outputting a respective plurality of reception signals (s) upon reception of said sound wave,
determining a propagation constant (α; α_{M,1}, α_{M,2}) of the received sound wave, as a function of said reception signals (s), said propagation constant being equal to the sine of a reception angle (θₒ) indicating the direction of reception of the sound wave with respect to the vertical, divided by a local propagation velocity (cₒ) of the sound waves at the depth of said receiving antenna,
determining a propagation time (t; t_{M,1}, t_{M,2}; t_{B}) of the sound wave, as a function of the duration separating the times of emission and reception of the sound wave, and
determining the depth difference (z_{P}, Δz; z_{M,1}, z_{M,2}, z_{M}; z_{B}), or the lateral deviation (y_{P}; x_{M}; x_{B}, y_{B}) with respect to the vertical, between the receiving antenna and the transmitter, or between the receiving antenna and a submerged element (P; M) reflecting said sound wave during its propagation from the transmitter to the receiving antenna, as a function of:
a product of said propagation time (t; t_{M,1}, t_{M,2}; t_{B}) by a mean velocity value (c_{moy}(z_{P}), c_{moy}(z_{M})) of the sound wave at a depth (z_{P}, z_{M}) of the transmitter or at a depth (z_{B}, z′_{B}) of the submerged element (P; M), said mean velocity value (c_{moy}(z_{P}), c_{moy}(z_{M})) being representative of a harmonic mean of a plurality of local propagation velocities (c), exhibited by the sound waves at a respective plurality of depths (z) from the depth of the transmitter to a depth of the receiving antenna, or from the depth of said submerged element (P; M) to the depth of the receiving antenna,
and as a function of
a mean propagation angle (θ_{moy}), defined between the vertical and an effective direction of propagation of the sound wave, the mean propagation angle (θ_{moy}) being determined as a function of said propagation constant (α; α_{M,1}, α_{M,2}) and of said mean velocity value (c_{moy}(z_{P}), c_{moy}(z_{M})) of the sound wave at the depth (z_{P}, z_{M}) of the transmitter or at the depth (z_{B}, z′_{B}) of the submerged element (P; M).

2. The method according to claim 1, wherein it is provided to determine both said depth difference (z_{P}, Δz; z_{M,1}, z_{M,2}, z_{M}; z_{B}) and said lateral deviation (y_{P}; x_{M}; x_{B}, y_{B}) with respect to the vertical.

3. The method according to claim 1, wherein said mean velocity value (c_{moy}(z_{P}), c_{moy}(z_{M})) is determined from a mean velocity profile (c_{moy(Z)}), the mean velocity profile (c_{moy(z)}) being determined by numerical integration of a local propagation velocity profile previously surveyed between the depth of the transmitter and the depth of the receiving antenna, or between the depth of said submerged element (P; M) and the depth of the receiving antenna.

4. The method according to claim 1, comprising a displacement of the receiving antenna in parallel to the receiving antenna's longitudinal axis from a first position (O1) to a second position (O2), and comprising the determination of a first propagation time of a first sound wave for the first position (O1) and a first propagation constant (α; α_{M,1}, α_{M,2}) of the received sound wave, and, respectively, a second propagation time of a second sound wave for the second position (O2) and a second propagation constant ((α_{M,2}), and wherein said mean velocity value (c_{moy}(z_{P}), c_{moy}(z_{M})) is determined as a function of the first propagation time, the second propagation time and the second propagation constant ((α_{M,2}).

5. The method according to claim 4, comprising the determination of a mean velocity profile (c_{moy}(z)) for a plurality of depths (z) comprised between the depth of the transmitter and the depth of the receiving antenna, or between the depth of said submerged element (P; M) and the depth of the receiving antenna, and the estimation of a local propagation velocity profile by a numerical method of inversion from the mean velocity profile (c_{moy(Z)}).

6. The method according to claim 1. wherein said depth difference (z_{P}, Δz; z_{M,1}, z_{M,2}, z_{M}; z_{B}) is determined in such a way as to exhibit a relative deviation lower than one per thousand with respect to:
the product of said propagation time (t; t_{M,1}, t_{M,2}; t_{B}) by said mean velocity value (c_{moy}(z_{P}), c_{moy}(z_{M})),
multiplied by the cosine of said mean propagation angle (θ_{moy}).

7. The method according to claim 1, wherein said lateral deviation is determined in such a way as to exhibit a relative deviation lower than one per thousand with respect to:
the product of said propagation time (t; t_{M,1}, t_{M,2}; t_{B}) by said mean velocity value (c_{moy}(z_{P}), c_{moy}(z_{M})),
multiplied by the sine of said mean propagation angle (θ_{moy}).

8. The method according to claim 1. wherein the mean propagation angle (θ_{moy}) is determined in such a way as its sine exhibits a relative deviation lower than one per thousand with respect to the product of said propagation constant (α; α_{M,1}, α_{M,2}) by said mean velocity value (c_{moy}(z_{P}), c_{moy}(z_{M})).

9. The method according to claim 1, wherein the mean propagation angle (θ_{moy}) is further determined as a function of an arithmetic mean velocity (c̅) that is representative of an arithmetic mean of a plurality of local propagation velocities (c), exhibited by the sound waves at a respective plurality of depths (z) from the depth of the transmitter to the depth of the receiving antenna, or from the depth of said submerged element (P; M) to the depth of the receiving antenna.

10. The method according to claim 9, wherein the mean propagation angle (θ_{moy}) is determined in such a way as a sine of the mean propagation angle exhibits a relative deviation lower than one per thousand with respect to said propagation constant (a) multiplied by said arithmetic mean velocity (c).

11. The method according to claim 1, wherein the transmitter and the receiving antenna are fitted on a same sonar system, and during which this sonar system determines the depth difference (z_{P}, Δz; z_{M,1}, z_{M,2}, z_{M}) or the lateral deviation (y_{P}; x_{M}) with respect to the vertical between the receiving antenna and a submerged element (P; M) reflecting said sound wave during its propagation of the sound wave from the transmitter to the receiving antenna.

12. The method according to claim 1, wherein the transmitter and the receiving antenna are respectively fitted on two distinct systems situated at different respective depths (z_{B}, zₒ), and, during which the system provided with the receiving antenna determines the depth difference (z_{B}) or the lateral deviation (x_{B}, y_{B}) with respect to the vertical between the receiving antenna and said transmitter.

13. The method according to claim 3, further comprising the following steps:
determining, by means of a sounder positioned successively at several different depths (z), a plurality of local propagation velocities (c) exhibited, at each of said depths (z), respectively, by the sound waves, then
determining the local propagation velocity profile as a function of said previously-determined plurality of local propagation velocities (c).

14. The method according to claim 4, wherein said mean velocity value (c_{moy}(z)) is determined in such a way as a deviation between:
said depth difference (z_{M,1}), and
a second depth difference (z_{M,2}) between the receiving antenna and the submerged element (M)
is lower than a given threshold, said second depth difference (z_{M,2}) being determined as a function of:
a product of said second propagation time (t_{M,2}) by said mean velocity value(c_{moy}), and as a function of
a second mean propagation angle, defined between the vertical and an effective direction of propagation of said second sound wave, said second mean propagation angle being determined as a function of said second propagation constant (α_{M,2}).

15. A method for determining a local propagation velocity (c) of the sound waves in an underwater environment (E), comprising the following steps:
for a plurality submerged elements (M, M′, M″) situated a different depths (z_{M}, z_{M}′, z_{M}″), determining a plurality of respective mean velocity values (c_{moy}(z_{M}), c_{moy}(z_{M}′), c_{moy}(z_{M}″)), each of said values being determined in accordance with the method defined in claim 14, then
determining a plurality of local propagation velocities (c) of the sound waves, for a plurality of given depths in the depth interval of the plurality of submerged elements, as a function of said previously-determined plurality of mean velocity values (c_{moy}(z_{M}), c_{moy}(z_{M}′), c_{moy}(z_{M}″)), and
determining at each of said submerged elements, from the previously-determined plurality of local propagation velocities and the associated propagation constants, the respective incidence angles of the sound wave.

16. A method for determining a position (x_{B}, y_{B}) of a submerged transmitter in an underwater environment (E), comprising the following steps:
emitting a sound wave in the underwater environment using said transmitter, whose depth (z_{B}) is known,
receiving said sound wave using at least one receiving antenna fitted on a surface or submersible vessel, the receiving antenna comprising several receivers outputting a respective plurality of reception signals (s),
determining a propagation constant (α) of the received sound wave, as a function of said reception signals (s), said propagation constant being equal to the sine of a reception angle (θ₀) indicating the direction of reception of the sound wave with respect to the vertical in a vertical plane (Pl) containing the transmitter and the receiving antenna, divided by a local propagation velocity (cₒ) of the sound waves at the depth (zₒ) of said receiving antenna,
determining an effective direction of propagation of the sound wave as a function of the product of said propagation constant (α) and a mean propagation velocity value (c_{moy}(z_{B})) at the depth (z_{B}) of the submerged transmitter, said mean velocity value (c_{moy}(z_{B})) being representative of a harmonic mean of a plurality of local propagation velocities (c), exhibited by the sound waves at a respective plurality of depths (z) between the depth (z_{B}) of the transmitter and the depth (zₒ) of the receiving antenna, and
determining a lateral deviation (x_{B}, y_{B}) with respect to the vertical between the receiving antenna and the transmitter, as a function of the product of:
the difference between the depth (z_{B}) of the transmitter and the depth (zₒ) of the receiving antenna, and of
the tangent of a mean propagation angle (θ_{moy}) defined between said effective direction of propagation and the vertical, the mean propagation angle (θ_{moy}) being determined as a function of said propagation constant (α) and said mean velocity value (c_{moy}(z_{B})) of the sound wave at the depth (z_{B}) of the transmitter.

17. A sonar system comprising:
a receiving antenna configured to receive a sound wave that has been previously emitted in an underwater environment by at least one transmitter (15, 16, 4), the receiving antenna comprising several receivers adapted to output a respective plurality of reception signals (s) upon reception of said sound wave, and
an electronic processing unit programmed to:
determine a propagation constant (α; α_{M,1}, (X_{M,2}) of the received sound wave, as a function of said reception signals (s), said propagation constant being equal to the sine of a reception angle (θₒ) indicating the direction of reception of the sound wave with respect to the vertical, divided by a local propagation velocity (cₒ) of the sound waves at the depth of said receiving antenna,
determine a propagation time (t; t_{M,1}, t_{M,2}; t_{B}) of the sound wave, as a function of a duration separating the times of emission and reception of the sound wave, and to
determine a depth difference (z_{P}, Δz; z_{M,1}, z_{M,2}, z_{M}; z_{B}), or a lateral deviation (y_{P}; x_{M}; x_{B}, y_{B}) with respect to the vertical, between the receiving antenna and the transmitter, or between the receiving antenna and a submerged element (P; M) reflecting said sound wave during propagation of the sound wave from the transmitter to the receiving antenna, as a function of:
a product of said propagation time (t; t_{M,1}, t_{M,2}; t_{B}) by a mean velocity value (c_{moy}(z_{P}), c_{moy}(z_{M})) of the sound wave, said mean velocity value (c_{moy}(z_{P}), c_{moy}(z_{M})) being representative of a harmonic mean of a plurality of local propagation velocities (c), exhibited by the sound waves at a respective plurality of depths (z) from the depth of the transmitter to a depth of the receiving antenna, or from the depth of said submerged element (P; M) to the depth of the receiving antenna, and as a function of
a mean propagation angle (θ_{moy}) defined between the vertical and an effective direction of propagation of the sound wave, the mean propagation angle (θ_{moy}) being determined as a function of said propagation constant (α; α_{M,1}, α_{M,2}) and said mean velocity value (c_{moy}(z_{P}), c_{moy}(z_{M})) of the sound wave at the depth (z_{P}, z_{M}) of the transmitter or at the depth (z_{B}, z′_{B}) of the submerged element (P; M).

18. A sonar system comprising:
a receiving antenna configured to receive a sound wave that has been previously emitted in an underwater environment by a transmitter whose depth (z_{B}) is known, the receiving antenna comprising several receivers adapted to output a respective plurality of reception signals (s) upon reception of said sound wave, and
an electronic processing unit programmed to:
determine a propagation constant (α) of the received sound wave, as a function of said reception signals (s), said propagation constant being equal to the sine of a reception angle (θₒ) indicating the direction of reception of the sound wave with respect to the vertical in a vertical plane (Pl) containing the transmitter and the receiving antenna, divided by a local propagation velocity (cₒ) of the sound waves at the depth (zₒ) of said receiving antenna,
determine an effective direction of propagation of the received sound wave, as a function the product of said propagation constant (α) and a mean propagation velocity value (c_{moy}(z_{B})) at the depth (z_{B}) of the transmitter, said mean velocity value (c_{moy}(z_{B})) being representative of a harmonic mean of a plurality of local propagation velocities (c), exhibited by the sound waves at a respective plurality of depths (z) from the depth of the transmitter to a depth of the receiving antenna,
acquire or read in a memory a data representative of the depth (z_{B}) transmitter, and to
determine a lateral deviation (x_{B}, y_{B}) with respect to the vertical, between the receiving antenna and the transmitter, as a function of the product of:
the difference between the depth (z_{B}) of the transmitter and the depth (zₒ) of the receiving antenna, and of
the tangent of a mean propagation angle (θ_{moy}) defined between said effective direction of propagation and the vertical, the mean propagation angle (θ_{moy}) being determined as a function of said propagation constant (α) and said mean velocity value (c_{moy}(z_{B})) of the sound wave at the depth (z_{B}) of the transmitter.

19. The method according to claim 2, wherein the transmitter and the receiving antenna are fitted on a same sonar system, and during which this sonar system determines the depth difference (z_{P}, Δz; z_{M,1}, z_{M,2}, z_{M}) or the lateral deviation (y_{P}; x_{M}) with respect to the vertical between the receiving antenna and a submerged element (P; M) reflecting said sound wave during its propagation from the transmitter to the receiving antenna.

20. The method according to claim 2, wherein the transmitter and the receiving antenna are respectively fitted on two distinct systems situated at different respective depths (z_{B}, zₒ), and, during which the system provided with the receiving antenna determines the depth difference (z_{B}) or the lateral deviation (x_{B}, y_{B}) with respect to the vertical between the receiving antenna and said transmitter.
